(19) United States
(12) Patent Application Publication
(10) Pub. No.: US 2024/0269753 A1
(43) Pub. Date: Aug. 15, 2024

(54) DRILL BIT, DRILL CHUCK ATTACHMENT FOR THE DRILL BIT AND ALSO DRILL CHUCK FOR THE DRILL BIT

(71) Applicant: Hilti Aktiengesellschaft, Schaan (LI)

(72) Inventors: Roland FOSER, Ruggell (LI); Xaver KÖPFER, Bernau (DE); Julian REICHARD, Karlsruhe (DE); Sarah NEUBAUER, Buchen (DE); Felix BASALLA, Ebhausen (DE); Leonhard FUCHS, Karlsruhe (DE); Julian SCHUMANN, Karlsruhe (DE); Sebastian ZIMPRICH, Karlsruhe (DE); Sven MATTHIESEN, Karlsruhe (DE)

(21) Appl. No.: 18/569,387

(22) PCT Filed: Jul. 6, 2022
(86) PCT No.: PCT/EP2022/068712

§ 371 Date: Dec. 12, 2023

(30) Foreign Application Priority Data
Jul. 8, 2021 (DE) 20 2021 103 665.6

(51) Int. Cl. B23B 47/34; B23B 45/00

(52) U.S. Cl. CPC B23B 47/34; B23B 45/003

(57) ABSTRACT

A drill bit having a chip channel which opens out into an annular gap volume formed by an adapter element is disclosed, along with a drill chuck attachment and a drilling machine.

The invention relates to a drill bit and also to a drill chuck attachment.

In a drilling process, harmful or otherwise undesired dust, rather than chips, is largely produced depending on the substrate to be drilled, in particular in the case of brittle or mineral materials. Particularly when drilling construction materials, construction dust and drilling dust, which have considerable potential for contamination and therefore also constitute a health risk in principle, are produced when using conventional drill bits. Masonry drilling is therefore undesired or impermissible without appropriate precautions.

However, drilling dust remaining in a borehole is often problematical since it has a negative influence on the holding values of fastening elements anchored in the borehole, such as dowels or casting compounds. The borehole has to be thoroughly cleaned for permitted fastening elements. Conventionally, this is done by time-consuming blowing or brushing said drilling dust out after the actual drilling operation.

As an alternative to subsequent cleaning of a borehole, suction drills are known, by way of which the drilling dust produced is extracted by suction at the same time as it is produced. Although suction drills of this kind protect the health of the user and save time in respect of cleaning boreholes, they are complicated to produce and therefore expensive to purchase. Since drills are parts that are subject to wear and have to be regularly replaced, their use is therefore not always economical.

Conventional suction drills consist of a drill bit, which is hollowed-out with a chip channel, and a suction nozzle connected to said chip channel. The drilling dust is extracted by suction through the chip channel at the drill tip and conducted through the extraction nozzle into a vacuum cleaner. A correspondingly matched extraction nozzle through which the drilling dust is conducted from the rotating drill shaft to the stationary vacuum cleaner is required for every drill bit diameter.

EP 3 150 347 B1 describes, by way of example, a drill bit with a central passage bore for extracting drilling dust by suction. Production is very expensive on account of the long passage bore.

By way of example, DE 10 2018 207 070 A1 and DE 10 2016 125 032 A1 disclose a sleeve drill with an extraction nozzle. Although these solutions are substantially more cost-effective in respect of production of the drill system, every sleeve drill requires an extraction adapter that is fixedly connected to said sleeve drill.

Extraction nozzles directly on the drill bit generate a large variety of parts and a large amount of expenditure on production and assembly, this resulting in high costs.

Proceeding from this, the object of the invention is to design a drill bit and also a drill chuck attachment for the drill bit and a drilling machine with the option of extraction by suction such that said drill bit, drill chuck attachment and drilling machine do not exhibit the abovementioned limitations or do so only to a reduced extent and ensure universal useability with as few components and as little expenditure on set up as possible.

The object is achieved by a drill bit, a drill chuck attachment and also a drilling machine having the features of claims 1, 12 and, respectively, 18. Dependent claims that refer back to said claims describe advantageous refinements.

A solution of the invention is based on a drill bit comprising a drill tip with cutting edges, a drill shaft and a drill portion arranged therebetween and also at least one continuous chip channel between the drill tip and the drill shaft, said chip channel being open on both sides and being enclosed by the drill portion.

The chip channel or channels can therefore be used as throughflow channels, preferably without diversions, from the drill tip directly to the drill shaft, wherein the drill portion is bridged without diversions. Said chip channels serve as extraction channels, wherein a vacuum can be applied to the drill shaft-side opening. Extraction by suction, in particular of drilling dust but also of drilling particles and/or drilling chips, from a borehole takes place at the open ends of the intake channels at the drill tip, wherein ambient air which is drawn in at the same time from the borehole serves as transportation gas. The chip channels are preferably designed to be optimized in terms of flow for this purpose, i.e. the flow cross section, apart from the open ends which are preferably expanded in a trumpet-like manner, has a flow cross section which is as constant as possible and has as few flow separating edges or deflections as possible.

One refinement of the chip channels makes provision for the drill portion to be formed by a helical drill core and to have a chip flute portion. In this case, the chip flute portion comprises has at least one continuous helical chip flute over its length, said chip flute being covered by a tubular sleeve so as to form a chip channel which is open on both sides. The chip flute portion is sheathed by the sleeve as part of the drill portion. Helical drill cores usually have two helical chip flute portions which start from two cutting edges. The drill tip with the main cutting edges preferably has a larger diameter than the sleeve without the adapter element.

However, the invention also comprises other refinements, for example tubular hollow drills with at least one central chip channel which is preferably redirected radially outward, optionally diverted into a plurality of radially outwardly opening partial channels, in the region of the drill shaft. The drill portion is formed by a tubular hollow drill core which encloses the chip channel.

It is conceivable for an adapter element to be provided with an, in particular standardizable, rotationally symmetrical outer face. Said outer face, starting from the drill portion, can extend with a spacing over an axial portion of the drill shaft so as to form an annular gap volume. The chip channel preferably opens out into the annular gap volume. A preferred refinement provides a separate component as the adapter element, said separate component being fitted onto the drill portion, such as e.g. the abovementioned sleeve, preferably in a sealing manner. The sleeve is further preferably composed of an elastic material, preferably of an elastic plastic or an elastic metal, this allowing the sleeve to yield with respect to a mating face in the case of contamination or in the event of particles becoming jammed. In this case, the outer face of the sleeve further preferably has an ability to yield elastically in a radially inwardly directed manner.

The outer face of the adapter element is preferably rotationally symmetrical and in this case cylindrical or in the shape of a truncated cone, at least in regions.

An alternative refinement makes provision for the adapter element to be provided in one piece with said sleeve, i.e. to be integrally formed on the sleeve. The adapter element is preferably arranged only at the proximal end of the drill portion, i.e. in the direction of the drill shaft, i.e. the adapter element does not overlap with the predominant part of the drill portion starting from the drill tip.

The drill shaft is preferably cylindrical at least in portions starting from the drill tip, i.e. the drill bit preferably has a uniform diameter preferably at least between the drill tip and the adapter element, the cutting edges arranged at the drill tip further preferably extending beyond said diameter at the drill tip.

A preferred refinement of the drill shaft provides an SDS fitting or another form-fitting fitting provided with grooves, tongues or other shaped elements.

The invention further proposes a drill chuck attachment for sheathing a chuck or a drill fitting (e.g. SDS or SDS+) of a drilling machine as a mating piece for the above-described drill bit in order to achieve the object. The drill chuck attachment substantially comprises an extraction volume, an extraction nozzle for connection of a suction hose and also an extraction receptacle with a, preferably standardizable, rotationally symmetrical inner face as a mating piece for the, preferably standardizable, rotationally symmetrical outer face of the above-described drill bit. The inner face and the outer face are arranged concentrically with respect to one another and one above the other at least in regions. They radially delimit an annular gap and thereby form an annular gap seal.

The drilling dust is conducted from the drilling tip, via the chip channel, in the direction of the drill chuck into the intake volume of the drill chuck attachment and from there, via the extraction nozzle, into the suction hose. Standardizing the interfaces, i.e. not only the drill fitting but also the abovementioned annular gap seal between the drill bit and the drill chuck attachment, with a uniform diameter means different drill diameters can advantageously be used with one and the same drill chuck attachment. In this case, a standardized drill fitting (e.g. SDS or SDS+) provided as original equipment is retained, and therefore this can still be used for drill bits that do not have the option of extraction by suction.

If the adapter element of the drill bit has an ability to yield elastically (flexibility) in an axially oriented manner described as a preferred refinement above, the outer face also expands outward as the rotation speed of the drill bit in the drilling machine increases, as a result of which the thickness of the abovementioned annular gap is advantageously also reduced. A further preferred refinement in this respect makes provision for said inner and outer faces of the annular gap seal to be provided with an encircling topography which engages into the respectively opposite face at least at relatively high rotation speeds. preferably angular encircling barriers. These barriers are preferably angular and therefore have separating edges which cause eddy currents in the case of a through-flowing gas in the annular gap and therefore increase the throughflow resistance. As the rotation speed increases, the topographies of the inner and outer faces are pushed into each other, as a result of which an encircling labyrinth seal is formed. An optional refinement of the encircling barriers in particular on said encircling outer face or inner face makes provision for these to be designed as an encircling sealing lip or sealing ring which makes contact with the respectively opposite inner or outer face only at a specific rotation speed and slides on it, this closing the annular gap.

The intake nozzle is preferably arranged on the side of the drill chuck attachment, wherein the extraction volume has a curved portion between the extraction receptacle and the intake nozzle and a lead-through for the drill shaft of the drill bit from the intake volume in the direction of the drill chuck is provided in the curved portion The drill chuck attachment, and therefore also the extraction nozzle, is/are further preferably axially rotatable about the drill bit axis here, in particular mounted over or on the drill chuck, this advantageously benefiting mechanical coupling of the drill chuck and the suction hose in at least one degree of freedom. The lead-through further preferably has a sealing means, preferably a gap seal or a sliding seal, further preferably an elastomeric seal and/or a sealing lip with respect to the drill shaft, this preventing drilling dust escaping from the extraction volume and counter to the suction vacuum in the direction of the drill chuck.

The drill chuck attachment is preferably attached to the housing of the drilling machine as an additional component. In principle, no changes have to be made to the housing of the drilling machine itself for the drill chuck attachment, this making it easier to retrofit existing machines.

Incorporating the extraction nozzle into the drill chuck attachment and not into the housing of the drilling machine additionally lowers the costs of a suction drill by considerably reducing the complexity of the system and therefore also the overall costs for each drilling operation. The independence of the drill chuck attachment from the device housing owing to the extraction nozzle rotatably mounted with the drill chuck attachment additionally ensures compatibility of the chuck with various machines. In order to change a drill bit, it is now also no longer necessary to remove the suction nozzle and fit it again after making the change, this saving additional set-up time on the construction site.

The drill chuck can still also be used with the drill chuck attachment fitted even with conventional drill bits, in particular without the abovementioned chip channel, and therefore this system is not required in parallel with other drill chucks.

In one class of embodiments, the drill chuck attachment additionally has at least one sensor. The sensor can be designed to measure a measurement value of a fluid property. in particular a flow rate, a throughflow quantity, a particle density and/or a particle type, in the extraction volume. The throughflow quantity can correspond to a quantity of fluid and/or particles per unit time.

The process of transporting away drilling dust, drilling chips or the like can be monitorable or monitored by means of the sensor. For example, an interruption in the transporting-away operation, such as for example due to blockage, can be identified in good time in this way. Corrective measures can be initiated if required.

The suction power can be controllable or controlled depending on the measurement value from the sensor, in particular depending on a change in the measurement value.

If, for example, a particularly high particle density and/or a particle type with a particularly high hazard potential, for example silica dusts, extremely fine dusts and the like, are identified, the suction power can be increased.

A degree of completion can also be determinable by means of the sensor. For example, a reduction in the particle density to below a specific limit value with a nevertheless sufficiently high air volume flow can indicate proper cleaning, in particular cleaning of the borehole having taken place to a specific degree and therefore sufficiently.

The sensor can be arranged and/or formed on the extraction nozzle. The sensor can be connected electrically and/or for data exchange to the drilling machine, on the drill chuck of which the drill chuck attachment is arranged.

If said sensor is formed on the extraction nozzle, it can be designed to examine the extraction volume in the region of the extraction nozzle.

The sensor can also be fitted, for example, to a suction hose. If the suction hose is fitted to the extraction nozzle, the sensor can be arranged on the extraction nozzle or subsequently arranged on it in this way. In particular, the sensor can be arranged such that it can be detached from the extraction nozzle.

The drill chuck attachment can also have at least one signal transmitter. The signal transmitter can have an optical and/or an acoustic signal transmitter.

The signal transmitter can be designed to be controlled depending on the measurement value from the sensor. For example, the signal transmitter can be designed to emit a warning sound if the measurement value indicates an excessively low throughflow, in particular a possible blockage.

The scope of the invention further covers a drilling machine comprising a drill chuck and a drill chuck attachment for the drill chuck. The drill chuck attachment can have one or more features of the drill chuck attachment described above and/or below. The drill chuck can be designed to receive an, in particular standardized, drill bit. For example, it can be designed to receive a drill bit according to the standard generally referred to as SDS, SDS Plus or SDS max.

In order to be usable for performing drilling work, in particular hammer drilling work, the drilling machine can be equipped with a drill bit. The drill bit can have one or more features of the drill bit described above and/or below.

If the drill chuck attachment of the drilling machine as described above and/or below has a sensor, the drilling machine can be designed to be controllable depending on the measurement value from the sensor.

Therefore, for example, a warning signal can be emitted by the drilling machine when the measurement value from the sensor indicates a critical state, for example a blockage. Similarly, a signal can be emitted when a desirable state is indicated by the measurement value. For example, an enable signal can be emitted when the measurement value indicates that a borehole drilled by the drilling machine has been sufficiently freed of drilling dust, drilling chips and the like, so that for example the borehole can be properly filled with a casting compound and/or a dowel.

As an alternative or in addition, it is conceivable for a motor of the drilling machine to be controlled or controllable depending on the measurement value. It is also conceivable for a documentation process be initiated, in which the measurement value and/or a state indicated by the measurement value or an event indicated by the measurement value is permanently stored, in particular documented.

The invention will be explained in more detail with reference to further exemplary embodiments and refinements and the following figures and descriptions. All the presented features and combinations thereof are not limited only to these exemplary embodiments and the refinements thereof. Rather, these should be considered to be representative of further possible refinements, not explicitly presented as exemplary embodiments, and able to be combined.

### IN THE DRAWING

FIG. 1a to FIG. 1d show, in schematic partial sectional views, a plurality of exemplary embodiments of drill bits, each having a tubular sleeve around the drill portion,

FIG. 2a to FIG. 2d show; in schematic partial sectional views, a plurality of exemplary refinements of a drill chuck attachment over a drill chuck, each with a drill bit according to FIG. 1a inserted,

FIG. 3 shows, in a schematic partial sectional view, an exemplary embodiment of a drill bit with a hollow drill core in a drill chuck attachment,

FIG. 4a and FIG. 4b show, in schematic sectional views, further drill bits in further drill chuck attachments, with the latter each having a sensor, and

FIG. 5 shows, in a schematic partial sectional view; a drilling machine with the drill chuck attachment and the drill bit according to FIG. 4b.

In the embodiments illustrated in the figures, a drill bit comprises a drill tip 1 with main cutting edges 2, a drill shaft 3 with a fitting for a drill chuck, in the example an SDS fitting 4, and also a drill portion 5 arranged therebetween and having at least one chip channel 6 which is open on both sides.

In addition, an encircling sealing face 7 is arranged on the drill shaft 3 proximal to the SDS fitting 4, as a sealing face for a drill chuck-side sealing system which rotates together with the drill bit and the drill chuck.

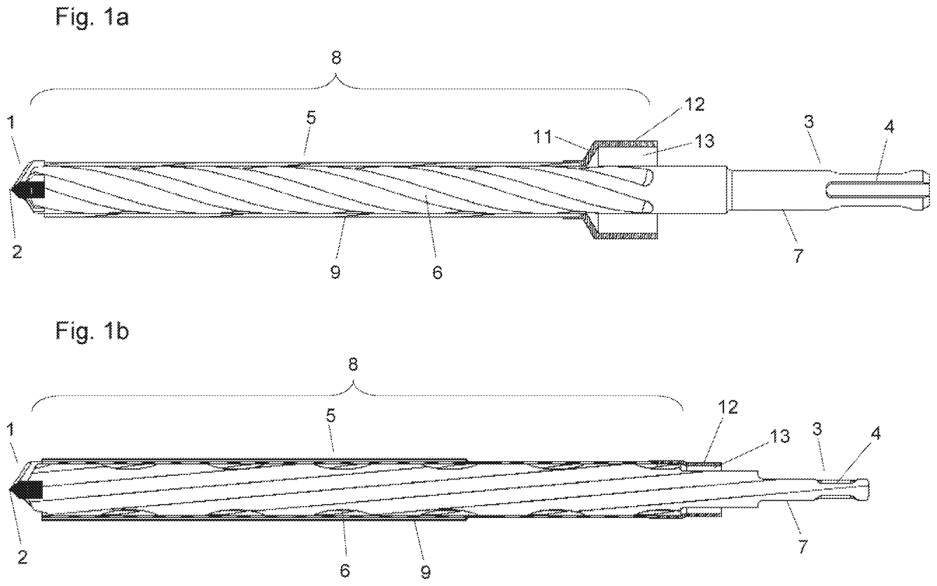

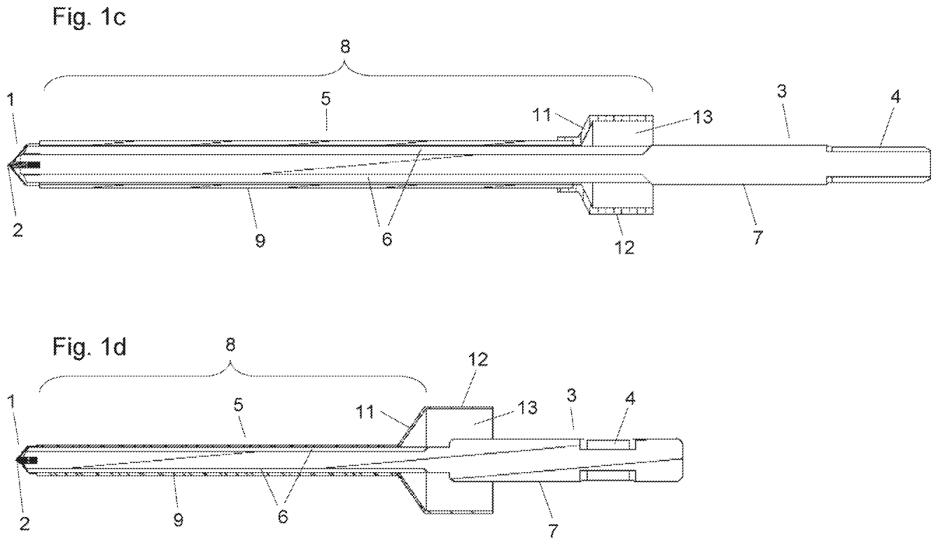

FIG. 1a to FIG. 1d each show a drill bit in which the drill portion 5 comprises a chip flute portion 8 with chip flutes which are sheathed by a tubular sleeve 9 as part of the drill portion 5 and the chip flute portion 8 and in this way form the outwardly terminated chip channels 6, which however are open on both sides in the regions of the drill tip and on the drill shaft 3, from the chip flutes. All of the illustrated drill tips 1 with the main cutting edges 2 preferably have a larger diameter than the sleeve 9.

The drill bit further comprises an adapter element 11 which, as illustrated in all of the figures, is arranged at the proximal end (starting from the drill shaft 3 or the SDS fitting 4) of the drill portion 5, i.e. in the direction of the drill shaft 3. The adapter element 11 is preferably sleeve-like and has a rotationally symmetrically encircling outer face 12, which is cylindrical in the exemplary embodiments shown. The adapter element 11 is either fitted, preferably pressed or adhesively bonded (cf. FIG. 1a and FIG. 1c), on the distal end of the sleeve 9 or integrally formed as part of this sleeve 9 (cf. FIG. 1b and FIG. 1d). Although the adapter element 11 has to be produced and applied separately as a separate component, it allows the use of a material that differs from the sleeve material (e.g. elastic plastic instead of an abrasion-resistant sleeve material) and therefore a material that is optimized for the respective intended application. It is also possible to design the sleeve 9 to be exchangeable (e.g. in order to change a drill bit for another drill chuck attachment with different geometric dimensions). Furthermore, there is a spacing with an annular gap volume 13, into which the chip channels 6 preferably open out as illustrated, between the drill portion 5 and the adapter element 11.

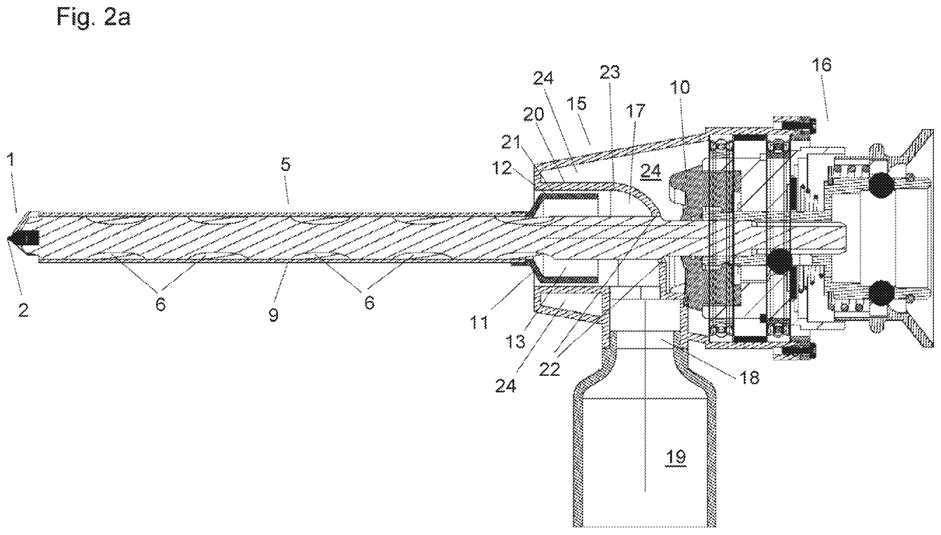

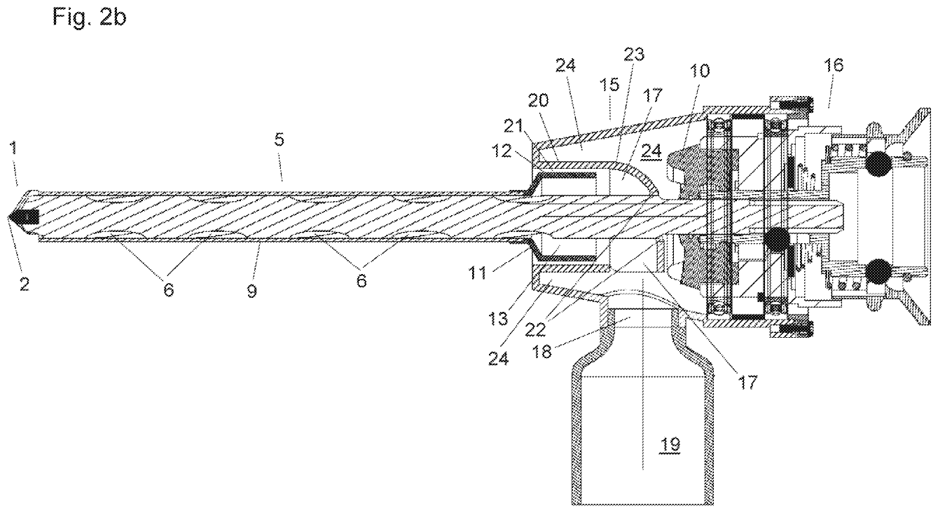

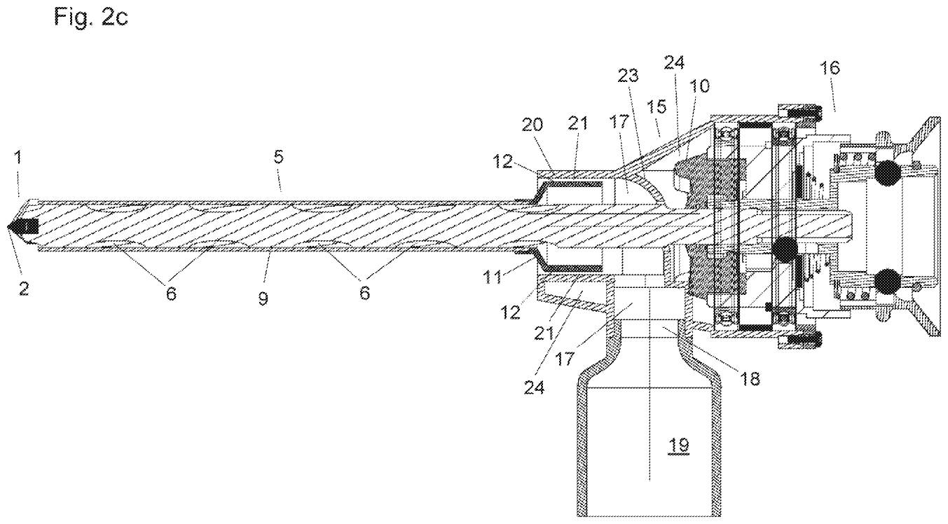

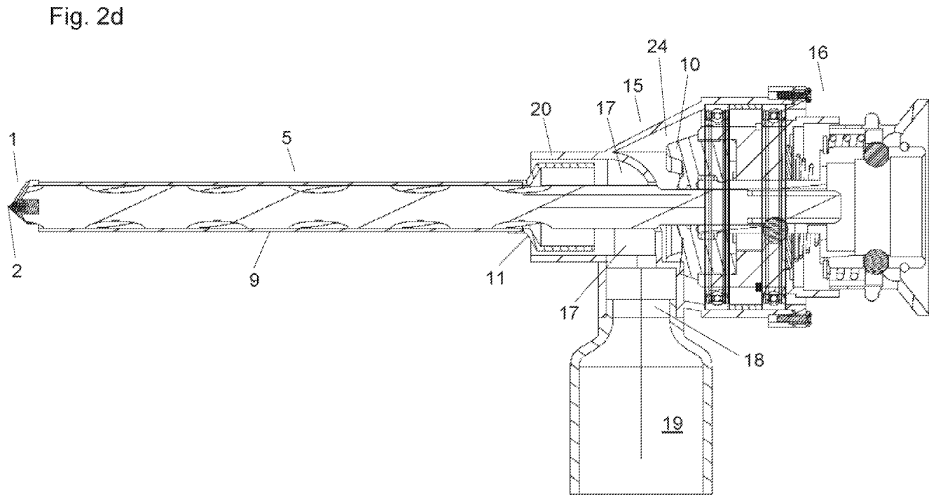

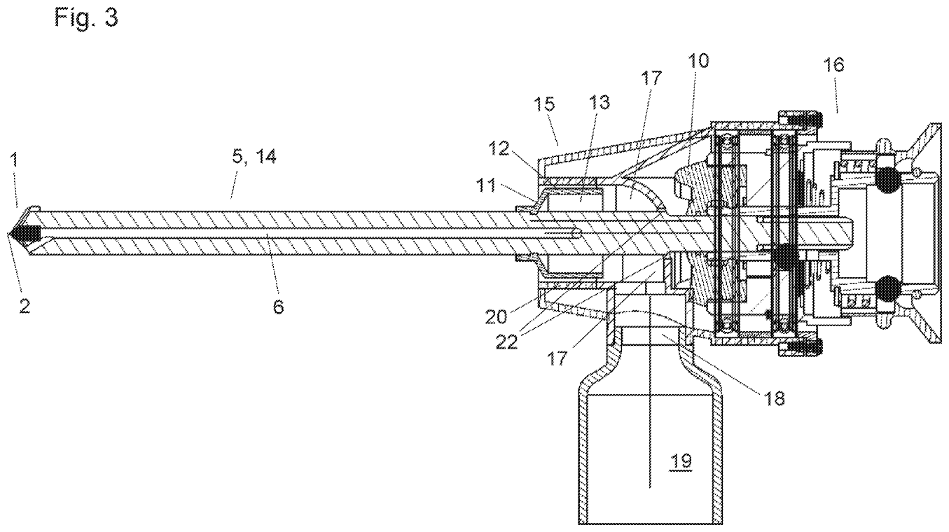

FIG. 2a to FIG. 2d and FIG. 3 represent, in schematic partial sectional views, a plurality of exemplary refinements of a drill chuck attachment 15 over a drill chuck 16 of a drilling machine, not illustrated any further, in each case with a drill bit according to FIG. 1a inserted. In this case, a drill chuck attachment comprises an extraction volume 17 (bent downward in the drawing) and an extraction nozzle 18 for connection of a suction hose 19 and also an extraction receptacle 20 with a, preferably standardizable, rotationally symmetrical inner face 21 as a mating piece for the, preferably standardizable, rotationally symmetrical outer face 12 of the above-described drill bit (cf. FIG. 2a). The inner face 21 and the outer face 12 are arranged concentrically with respect to one another and, as illustrated, one above the other, preferably in parallel, so as to form an annular gap. The smaller the minimum cross-sectional area of this annular gap, the advantageously smaller the proportion of secondary air which is sucked in in principle owing to the extraction by suction via the extraction receptacle 20.

In addition, FIG. 3 represents a drill bit in which the drill portion 5 is formed by a tubular hollow drill core 14 with a central chip channel 6 which opens out in the proximal region of the drill portion below the sleeve 11.

The drill bit passes through the intake volume 17, in a manner clamped in the drill chuck 16, via the extraction receptacle 20 and from there via an opening 22 (lead-through, aperture) and the above-mentioned sealing system into the SDS chuck. In the example, the sealing system is part of the drill chuck 16, is inserted into said drill chuck and comprises an elastomeric component 10 which rotates together with the drill chuck 16 and the drill bit and has a central bore (cf. FIG. 2a to FIG. 2d and FIG. 3) which rests in a sealing manner on the encircling sealing face of the drill shaft 3. Said elastomeric component prevents contamination in the drill chuck 16.

FIG. 2a to FIG. 2d and FIG. 3 show different refinements of the drill chuck attachment 15 which differ firstly in terms of the slimness of their outer contour and secondly in terms of the delimiting of the extraction volume 17.

FIG. 2a, FIG. 2c and FIG. 2d and also FIG. 3 show designs with a closed suction air guide, the extraction volumes 17 of which are delimited by the walls 23 thereof.

FIG. 2b on the other hand illustrates a suction air guide in which the remaining volumes of the drill chuck attachment 15 are also designed to be open to the extraction nozzle 18, as a result of which the quantities of drilling dust diverted into said volumes can advantageously also be detected and extracted by suction by the extraction by suction operation. Secondly, it is possible with such a refinement for the outer housing and the suction air guide to be provided as separate components of the drill chuck attachment 15, wherein in particular the inner face 21 can be exchangeably designed as an exchangeable part.

FIG. 2c and FIG. 2d represent, by way of example, slim designs which are distinguished in particular by a reduced physical size and a reduced weight in the distal region of the drill chuck attachment 15 in the direction of the opening 20, but equally do not have the mechanical robustness to mechanical action on the drill chuck attachment 15 in general and in particular for the inner face 21. A further advantage is found in the ability to produce the housing of the drill chuck attachment 15 more easily since it can be produced without undercuts, e.g. by injection molding.

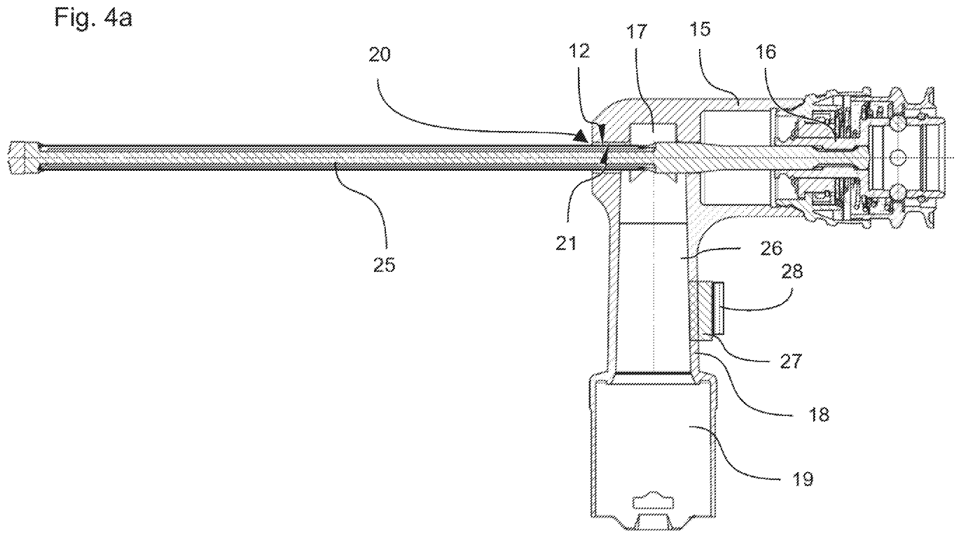

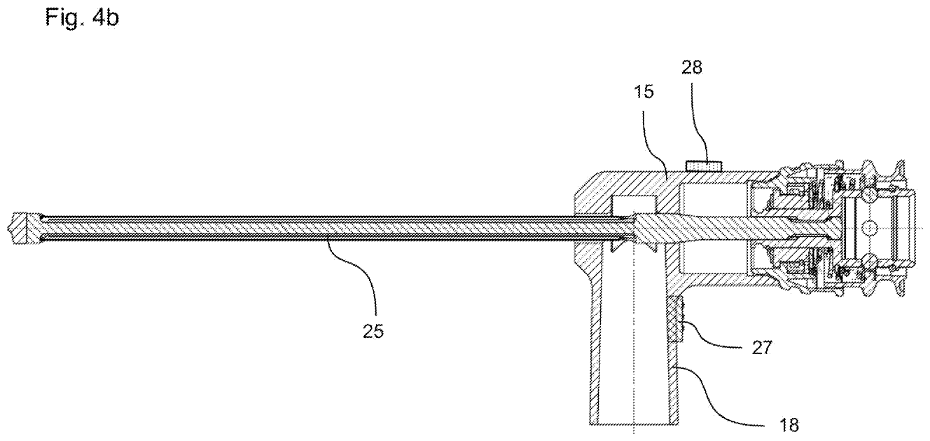

FIG. 4a shows, in a schematic longitudinal sectional view, a further drill chuck attachment 15, a drill bit 25 being arranged so as to run through said drill chuck attachment. The drill bit 25 is received in a drill chuck 16.

The drill chuck attachment 15 is arranged on the drill chuck 16, in particular is pushed onto it.

The drill chuck attachment 15 corresponds to the above-described drill chuck attachments 15, unless described otherwise.

In particular, said drill chuck attachment has an extraction volume 17 which extends from its extraction receptacle 20 to its extraction nozzle 18.

Said extraction volume has a rotationally symmetrical inner face 21 in the region of the extraction receptacle 20. The inner face 21 is designed as a mating piece for a rotationally symmetrical outer face 12 of the drill bit 25, so that once again an annular gap seal is formed between the outer face 12 and the inner face 21.

The drill bit 25 is in the form of a suction drill. The outer face 12 can correspond to a standardized shape. For example, the suction drill can correspond overall to a standard which is generally referred to for example as “SDS”, “SDS Plus” or “SDS Max” or the like. The drill bit 25 is, in particular, a hammer suction drill.

In the exemplary embodiment illustrated in FIG. 4a, there is no adapter element, by way of example. Accordingly, the diameter of the inner face 21 is selected to correspond to the diameter of the outer face 12 plus a small add-on for forming the annular gap seal.

It is also feasible here, in particular in order to also be able to use other drill bits, in particular drill bits which correspond to a different standard, to provide an adapter element corresponding to the above-described adapter elements 11, in particular with widening of the diameter of the inner face 21.

A special feature of the embodiment illustrated in FIG. 4a is that the drill chuck attachment 15 has a sensor 27. The sensor 27 is a throughflow sensor. It measures, as the measurement value, a volume flow flowing through the extraction nozzle 18.

For this purpose, a suction hose 19 is fitted in the extraction nozzle 18. The sensor sits at a mouth 26 of the suction hose 19 and projects through a corresponding opening in the extraction nozzle 18.

The drill chuck attachment 15 further has a signal transmitter 28. The signal transmitter 28 is in the form of an optical signal transmitter, in particular comprising an LED. Said signal transmitter is designed to emit a warning signal, for example to light up in red, as soon as the measurement value from the sensor 27 indicates an excessively low volume flow.

FIG. 4b shows, in a schematic longitudinal sectional view, a further drill chuck attachment 15, a drill bit 25 being arranged so as to run through said drill chuck attachment. This drill chuck attachment 15 corresponds to the drill chuck attachment 15 according to FIG. 4a, unless mentioned otherwise in the text which follows.

In contrast to this however, the sensor is not arranged on the suction hose 19 (see FIG. 4a) but rather directly on the extraction nozzle 18. Therefore, said sensor is always available together with the drill chuck attachment 15.

The sensor 28 is further arranged on a top side of the drill chuck attachment 15. As a result, the visibility of said sensor is improved depending on the situation in which the drilling work is performed.

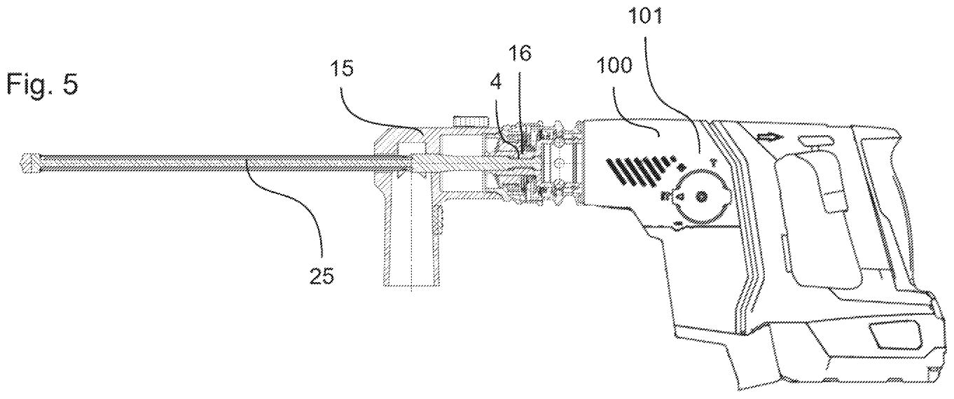

FIG. 5 shows, in a schematic, partially sectioned view, a drilling machine 100. The drilling machine 100 is in the form of a hammer drilling machine

A drill chuck attachment 15 is arranged on the housing 101 of said drilling machine, in particular on the drill chuck 16 of said drilling machine.

A drill bit 25 projects through the drill chuck attachment 15.

The drill bit 25 is received in the drill chuck 16. The drill bit is in the form of a suction drill and also in the form of a hammer drill, in particular for drilling stone, such as concrete for example.

It has an SDS fitting 4.

In the exemplary embodiment illustrated in FIG. 5, the drill chuck insert 15 and the drill bit 25 correspond to the corresponding elements according to FIG. 4b. As an alternative, it is also conceivable for the drill chuck insert 15 and/or the drill bit 25 to correspond to one of the other, above-described embodiments of the corresponding elements.

### LIST OF REFERENCE SIGNS

1 Drill tip
2 Main cutting edge
3 Drill shaft
4 SDS fitting
5 Drill portion
6 Chip channel
7 Encircling sealing face
8 Chip flute portion
9 Sleeve
10 Elastomeric component
11 Adapter element
12 Outer face
13 Annular gap volume
14 Hollow drill core
15 Drill chuck attachment
16 Drill chuck
17 Extraction volume
18 Extraction nozzle
19 Suction hose
Extraction receptacle
21 Inner face
22 Opening
23 Wall of the extraction volume
24 Remaining volumes of the drill chuck attachment
25 Drill bit
26 Mouth
27 Sensor
28 Signal transmitter
100 Drilling machine
101 Housing

1. A drill bit, comprising
a) a drill tip with main cutting edges, a drill shaft and a drill portion arranged therebetween and also
b) at least one continuous chip channel between the drill tip and the drill shaft, said chip channel being open on both sides and being enclosed by the drill portion, wherein
c) an adapter element is provided with a rotationally symmetrical outer face, said outer face, starting from the drill portion, extending with a spacing over an axial portion of the drill shaft so as to form an annular gap volume, and
d) the at least one continuous chip channel opens out into the annular gap volume.

2. The drill bit as claimed in claim 1, wherein
a) the drill portion is formed by a helical drill core,
b) the drill portion with the at least one chip flute portion is sheathed by a tubular sleeve as part of the drill portion and also
c) the at least one continuous chip channel is formed by the at least one chip flute portion on the helical drill core, wherein
d) the at least one chip flute portion has at least one continuous helical chip flute over its length, said at least one chip flute portion being partially covered by the tubular sleeve so as to form a chip channel which is open on both sides, and also
e) the adapter element is fitted on the tubular sleeve or integrally formed on the tubular sleeve.

3. The drill bit as claimed in claim 2, wherein the drill tip with the main cutting edges has a larger diameter than the tubular sleeve without the adapter element.

4. The drill bit as claimed in claim 1, wherein
a) the drill portion is formed by a tubular hollow drill core which encloses the chip channel and
b) the at least one continuous chip channel is routed radially to the outside in the region of the drill shaft.

5. The drill bit as claimed in claim 1, wherein the drill shaft, starting from the drill tip is cylindrical, at least in portions.

6. The drill bit as claimed in claim 1, wherein the drill shaft has an SDS fitting.

7. The drill bit as claimed in claim 1, wherein the adapter element is arranged at the proximal end of the drill portion.

8. The drill bit as claimed in claim 1, wherein the adapter element is a separate component.

9. The drill bit as claimed in claim 8, wherein the separate component consists of an elastic plastic or an elastic metal sleeve.

10. The drill bit as claimed in claim 8, wherein the separate component on the outer face of the sleeve has an ability to yield elastically in a radially inwardly directed manner.

11. The drill bit as claimed in claim 1, wherein the rotationally symmetrical outer face is cylindrical or in the shape of a truncated cone, at least in regions.

12. A drill chuck attachment for sheathing a drill chuck of a drilling machine, comprising an extraction volume and an extraction nozzle and also an extraction receptacle with a rotationally symmetrical inner face as a mating piece for a rotationally symmetrical outer face of a drill bit as claimed in claim 1 for a gap seal.

13. The drill chuck attachment as claimed in claim 12, wherein the intake nozzle is arranged on the side of the drill chuck attachment and the extraction volume has a curved portion between the extraction receptacle and the intake nozzle, wherein an opening for the drive shaft of the drill bit in a direction of the drill chuck is provided in the curved portion.

14. The drill chuck attachment as claimed in claim 13, wherein the opening has a sealing means with respect to the drill shaft.

15. The drill chuck attachment as claimed in claim 12, additionally having at least one sensor which is designed to measure a measurement value of a fluid property in the extraction volume.

16. The drill chuck attachment as claimed in claim 15, wherein the at least one sensor is arranged and/or formed on the extraction nozzle.

17. The drill chuck attachment as claimed in claim 12, additionally having at least one signal transmitter.

18. A drilling machine, comprising a drill chuck and a drill chuck attachment as claimed in claim 12 for the drill chuck.

19. The drilling machine, as claimed in claim 18, additionally comprising a drill bit comprising
a) a drill tip with main cutting edges, a drill shaft and a drill portion arranged therebetween and also
b) at least one continuous chip channel between the drill tip and the drill shaft, said chip channel being open on both sides and being enclosed by the drill portion, wherein
c) an adapter element is provided with a, preferably standardizable, rotationally symmetrical outer face, said outer face, starting from the drill portion, extending with a spacing over an axial portion of the drill shaft so as to form an annular gap volume, and
d) the at least one continuous chip channel opens out into the annular gap volume.

20. The drilling machine as claimed in claim 18 and in conjunction with a drill chuck attachment having a sensor designed to measure a measurement value of a fluid property in the extraction volume the drilling machine can be controlled depending on the measurement value of the sensor.
